(19) United States
(12) Patent Application Publication
(10) Pub. No.: US 2012/0076655 A1
(43) Pub. Date: Mar. 29, 2012

(54) THREE ROW ROLLER BEARING, IN PARTICULAR FOR A WIND TURBINE

(76) Inventor: Henrik Stiesdal, Odense C (DK)

(21) Appl. No.: 13/215,720

(22) Filed: Aug. 23, 2011

(30) Foreign Application Priority Data
Sep. 27, 2010 (EP) EP10180129

(51) Int. Cl. F16C 19/38; F03D 11/04

(52) U.S. Cl. 416/174; 384/455

(57) ABSTRACT

A three row roller bearing, in particular for a wind turbine, is provided. The three row roller bearing includes a row of radial rollers receiving radial load and a pair of rows of axial rollers receiving axial load. The axial rollers are tapered. A wind turbine using the three row roller bearing is also provided.

### CROSS REFERENCE TO RELATED APPLICATIONS

This application claims priority of European Patent Office application No. 10180129.8 EP filed Sep. 27, 2010, which is incorporated by reference herein in its entirety.

### FIELD OF INVENTION

The present invention relates to a three row roller bearing, in particular for a wind turbine, comprising a row of radial rollers receiving radial load and a pair of rows of axial rollers receiving axial load.

### BACKGROUND OF INVENTION

Wind turbines are provided with a rotor shaft which is part of an electrical generator producing electricity during movement of the rotor relative to a stator of the generator. The stator comprises a number of coils, the rotor may comprise a number of permanent magnets or electrically charged magnets so that an electric voltage is induced when the rotor is turned.

In recent years a trend towards wind turbines with increased power can be observed which require large main shaft bearings. In large main shaft bearings temperature differences between an outer ring and an inner ring of the bearing may occur. Main shaft bearings may have large radial dimensions, e.g. a diameter of 2500 mm or more, whereas the width may only be in the size of e.g. 100-300 mm. These large bearing diameters require quite large radial tolerances leading to a large clearance in the radial direction to avoid damage of the bearing. Even small temperature differences of about one degree require a large clearance to avoid damage. However, the clearances can not be enlarged arbitrarily. Large radial tolerances of a main shaft bearing may lead to problems with large looseness so that adhesive wear of the rollers is promoted due to skid or smear bearing problems.

In order to avoid problems with tolerances of bearings for wind turbines it has been proposed to use two or more bearings to support the main shaft, in particular two radial rotor bearings and one axial roller bearing, placed along the main shaft. However, to use three single bearings is an expensive solution which takes up more space than just one large bearing. In EP 1 677 005 A1 a wind turbine is disclosed with a three row cylindrical roller bearing for a main shaft where the main shaft is connected to an input shaft of a gear box, the main shaft is supported to a nacelle by a single three row roller bearing comprising one row of rollers receiving a radial load and a pair of rows of rollers receiving a thrust load. The thrust load rollers are cylindrical rollers which may give adhesive wear due to skid problems as the radial speed increases along the rollers as the radial distance of the centreline of the bearing increases along the rollers.

### SUMMARY OF INVENTION

It is therefore an object of the present invention to provide a three row roller bearing, in particular for a wind turbine, which does not suffer from adhesive wear even when temperature differences occur.

According to the present invention this object is achieved in the above defined three row roller bearing in that the axial rollers are tapered.

Due to the tapered axial rollers instead of cylindrical rollers the skid problems due to the increasing radial speed along the rollers are avoided. Therefore the inventive three row roller bearing guarantees a longer service life compared to a conventional three row roller bearing.

According to a further development of the inventive three row roller bearing it may comprise at least one outer ring receiving the axial rollers and/or at least one inner ring receiving the axial rollers. In the inventive three row roller bearing the tapered axial rollers receive only axial loads, whereas radial loads are received by an outer ring.

According to a preferred embodiment of the invention the at least one outer ring or the at least one inner ring may receive the tapered rollers in a recess. The inventive three row roller bearing is less sensitive to temperature differences between the outer ring and the inner ring as it is possible to have large radial tolerances giving a large clearance between the outer ring and the inner ring.

Preferably, in the inventive three row roller bearing

the recess in the outer ring receives all the tapered shape of the tapered axial rollers. The dimensional tolerances of the inner ring and the outer ring provide a larger clearance in the radial direction than in the axial direction. The different clearances support the compensation of temperature differences between the inner and outer ring.

In one embodiment of the inventive three row roller bearing the rollers may roll and move freely between the inner and outer ring.

In an alternative embodiment of the inventive three row roller bearing the rollers are connected to one or more roller cages holding the rollers in specific positions while rotating and rolling.

According to a further development of the invention the three row roller bearing may be prestressed by an axial force. When the three row roller bearing is prestressed problems with looseness and related adhesive wear are avoided.

The inventive three row roller bearing may comprise a dynamic sealing between the at least one outer ring and the at least one inner ring.

Further the invention refers to a wind turbine, preferably comprising a main shaft, a hub, a generator stator part and/or a generator rotor part.

The main shaft, the hub and/or the generator rotor part of the inventive wind turbine may be supported by a three row roller bearing as explained above.

The inventive wind turbine may be a gearless direct drive wind turbine.

### BRIEF DESCRIPTION OF THE DRAWINGS

The invention and its underlying principle will be better understood when consideration is given to the following description of a preferred embodiment.

In the accompanying drawings:

FIG. 1 is a first perspective sectional view of an embodiment of an inventive three row roller bearing;

FIG. 2 is a second sectional view of the three row roller bearing of FIG. 1; and

FIG. 3 is a sectional view of the three row roller bearing of FIG. 1.

### DETAILED DESCRIPTION OF INVENTION

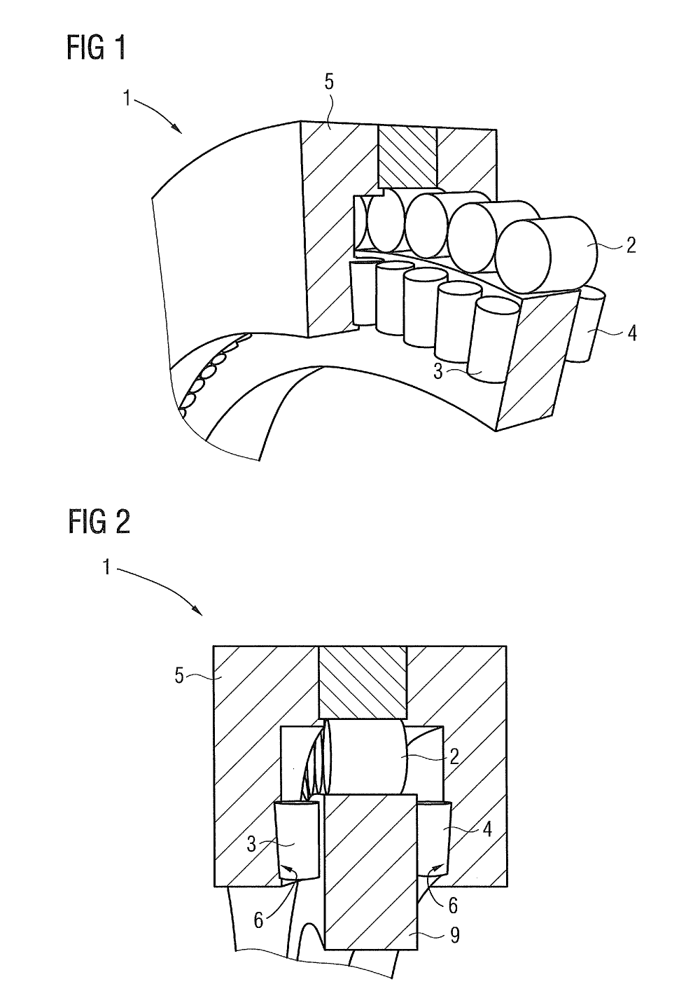

FIGS. 1 and 2 show a portion of a three row roller bearing 1, comprising a row of radial rollers 2 and a pair of rows of axial rollers 3, 4 receiving axial load. The axial rollers 3, 4 are tapered which means that their outer diameter is larger than their inner diameter.

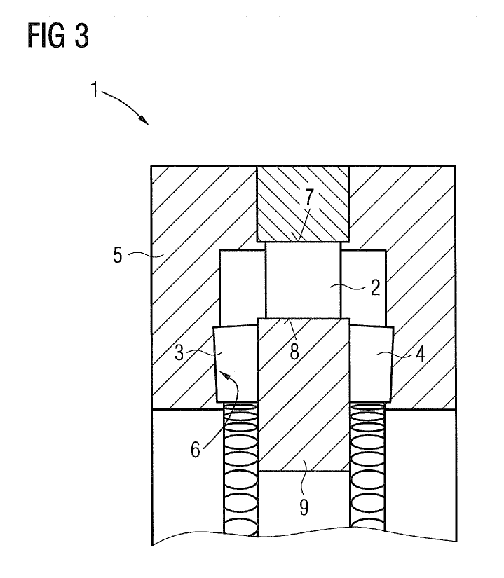

The three row roller bearing 1 comprises one outer ring 5 receiving the axial rollers 3, 4. As can be seen best in FIG. 3 the radial rollers 2 are contacting a bearing surface 7 of the outer ring 5 on one side and a bearing surface 8 of an inner ring 9 on the other side.

In the outer ring 5 a recess 6 is provided which receives all the tapered shape of the tapered axial rollers 3, as is shown in FIG. 3. The inner ring 9 has a non-tapered surface lying against the vertical surface of the tapered axial rollers 3. In this way the radial clearance may be large without damaging the tapered axial rollers.

The dimensional tolerances of the inner ring 9 and the outer ring 5 provide a larger clearance in radial direction than in axial direction, in order to compensate for temperature differences between the inner ring 9 and the outer ring 5.

The three row roller bearing 1 is in particular appropriate for use in a wind turbine. The three row roller bearing may be used to support a main shaft, a hub and/or a generator rotor part of a wind turbine which is preferably a gearless direct drive wind turbine. One part of the three row roller bearing 1 may be connected to a static structure part, e.g. a nacelle or a tower, or a generator stator part of the wind turbine and another part of the three row roller bearing may be connected to the rotatable main shaft, a hub and/or a generator rotor part of the wind turbine. In general one or more rotating and/or static parts of a wind turbine may be connected to the three row roller bearing.

The generator of a gearless direct drive wind turbine may comprise an outer rotor and an inner stator where the rotor and/or the stator is/are connected to the three row roller bearing.

1-14. (canceled)

15. A three row roller bearing, comprising:
a plurality of rollers, comprising:
a row of radial rollers receiving a radial load, and
a pair of rows of tapered axial rollers receiving an axial load.

16. The three row roller bearing according to claim 15, wherein at least one of the rollers rolls and moves freely.

17. The three row roller bearing according to claim 15, wherein at least one of the rollers is connected to a roller cage which holds the at least one of the rollers.

18. The three row roller bearing according to claim 15, further comprises an axial force prestress.

19. The three row roller bearing according to claim 15, further comprises:
a plurality of rings, comprising;
an outer ring which receives the tapered axial rollers, and
an inner ring, which is arranged between the pair of rows, receives the tapered axial rollers.

20. The three row roller bearing according to claim 19, wherein at least one of plurality of rings includes a recess in which the taper axial rollers are received.

21. The three row roller bearing according to claim 19, wherein the outer ring includes a recess in which all of a tapered shape of the tapered axial rollers are arranged.

22. The three row roller bearing according to claim 19, wherein dimensional tolerances of the inner ring and of the outer ring provide a larger clearance in a radial direction than in an axial direction.

23. The three row roller bearing according to claim 19, further comprises a dynamic sealing between the outer ring and the inner ring.

24. The three row roller bearing according to claim 15, further comprises:
an outer ring which receives the tapered axial rollers; or
an inner ring, which is arranged between the pair of rows, receives the tapered axial rollers.

25. The three row roller bearing according to claim 24, wherein the outer ring or the inner ring includes a recess in which the taper axial rollers are received.

26. The three row roller bearing according to claim 24, wherein the outer ring includes a recess in which all of a tapered shape of the tapered axial rollers are arranged.

27. The three row roller bearing according to claim 24, wherein dimensional tolerances of the inner ring or of the outer ring provide a larger clearance in a radial direction than in an axial direction.

28. A wind turbine, comprising
a rotating part; and
a static part;
a three row roller bearing according to claim 15, wherein the rotating part and/or the static part is connected the three row roller bearing.

29. The wind turbine according to claim 28, wherein the rotating part comprises a hub and/or a main shaft and/or a generator rotor.

30. The wind turbine according to claim 28, wherein the static part comprises a generator stator.

31. The wind turbine according to claim 28, wherein the wind turbine is a gearless direct drive wind turbine.

32. The wind turbine according to claim 32, wherein a generator of the gearless direct drive wind turbine comprises an outer rotor and an inner stator.
